(19) United States
(12) Patent Application Publication
(10) Pub. No.: US 2017/0102364 A1
(43) Pub. Date: Apr. 13, 2017

(54) ASCERTAINING POSITION OF A PISTON IN A CYLINDER

(71) Applicants: Andreas Hill, Essen (DE); Constantin Timm, Hattingen (DE); Rene Pekkola, Ludwigshafen (DE)

(72) Inventors: Andreas Hill, Essen (DE); Constantin Timm, Hattingen (DE); Rene Pekkola, Ludwigshafen (DE)

(21) Appl. No.: 15/288,668

(22) Filed: Oct. 7, 2016

Related U.S. Application Data
(60) Provisional application No. 62/238,353, filed on Oct. 7, 2015.

(51) Int. Cl. G01N 29/07

(52) U.S. Cl. CPC G01N 29/07; G01N 2291/269; G01N 2291/105; G01N 2291/011

(57) ABSTRACT

A hydraulic apparatus includes a cylinder having an end wall and a piston. An ultrasonic assembly has components configured to operate as an ultrasonic transmitter and two ultrasonic receivers. At least each of the components configured to operate as the receivers is disposed in separate bores separated by a known distance in a direction toward the piston. A control circuit is configured to initiate generation of an ultrasonic wave and receive input signals indicative of reflection of the ultrasonic wave off of the piston. The control circuit is configured to provide an output signal indicative of a distance of the piston from the end wall accounting for acoustic characteristics of the hydraulic fluid as ascertained from changes in the time difference between receipt of the input signals from the components configured to operate as receivers.

### CROSS-REFERENCE TO RELATED APPLICATION

The present application is based on and claims the benefit of U.S. provisional patent application Ser. No. 62/238,353, filed Oct. 7, 2015, the content of which is hereby incorporated by reference in its entirety.

### BACKGROUND

The discussion below is merely provided for general background information and is not intended to be used as an aid in determining the scope of the claimed subject matter. The invention relates to accurately ascertaining a position of a piston in a cylinder filled with hydraulic fluid.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they in-tended to be used as an aid in determining the scope of the claimed subject matter. The claimed subject matter is not limited to implementations that solve any or all disadvantages noted in the Background.

A hydraulic apparatus includes a cylinder having an end wall and an inner wall. A piston is disposed in the cylinder and movable with respect to the end wall. An ultrasonic assembly has components configured to operate as an ultrasonic transmitter and two ultrasonic receivers. Each of the components is secured in a fixed position to the end wall, wherein each of the ultrasonic transmitter and receivers components are disposed within a bore having an opening facing a surface of the piston and bounded by an inner wall. At least each of the components configured to operate as the receivers is disposed in separate bores separated by a known distance in a direction toward the piston. A control circuit is connected to the transmitter and each of the receiver components and is configured to initiate generation of an ultrasonic wave from the component configured to operate as the ultrasonic transmitter and receive input signals from each of the components configured to operate as the ultrasonic receivers indicative of reflection of the ultrasonic wave off of the piston. The control circuit is configured to provide an output signal indicative of a distance of the piston from the end wall accounting for acoustic characteristics of the hydraulic fluid as ascertained from changes in the time difference between receipt of the input signals from the components configured to operate as receivers. In one embodiment, the components can include separate transmitters and receivers.

In other embodiments, the ultrasonic assembly can include an ultrasonic transducer, which can operate both as a transmitter and a receiver, as well as a second receiver. The piston cylinder assembly can be a single acting piston or a double acting piston. A second ultrasonic assembly along with a second control circuit can be provided to measure a distance of the piston from a second end wall if desired.

### BRIEF DESCRIPTION OF THE DRAWINGS

FIG. 1 is a diagrammatic sectional side elevation of a piston within a cylinder with an ultrasonic transmitter and two ultrasonic receivers.

FIG. 2 is a diagrammatic sectional side elevation of a double-acting piston within a cylinder with first and second pairs of an ultrasonic transducer and an ultrasonic receiver.

FIG. 3 is a sectional view taken along lines 3-3 of FIG. 1

### DETAILED DESCRIPTION OF ILLUSTRATIVE EMBODIMENTS

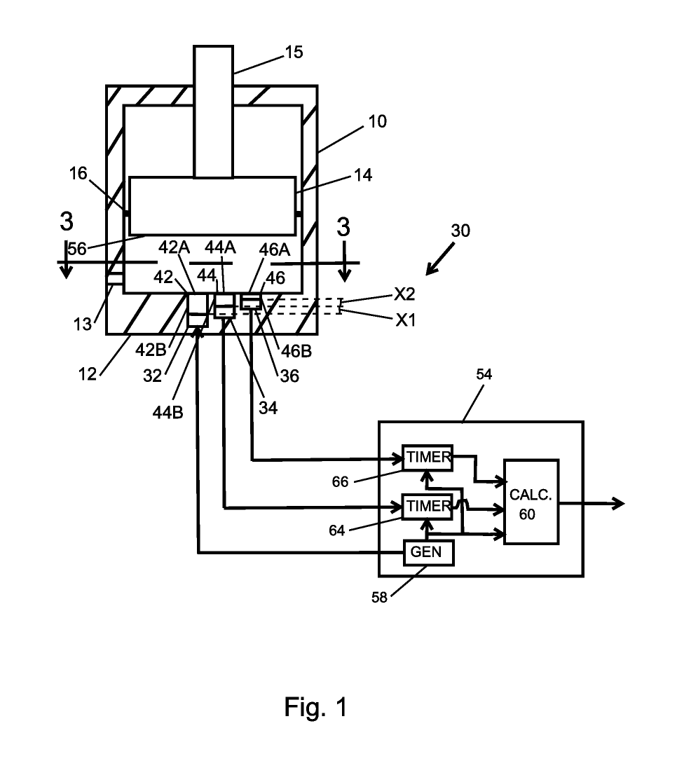

FIG. 1 illustrates an ultrasonic transducer comprising a cylinder 10 closed at its lower end by an end wall 12. An inlet 13 allows hydraulic fluid to be transferred into and out of the cylinder. A piston 14 is displaceable in the cylinder 10. Commonly, a piston rod 15 is attached to the piston 14 and extends in a direction away from the end wall 12. One or more seals 16 are disposed about a perimeter surface of the piston 14 facing an interior wall of the cylinder 10. The seal(s) help maintain a sealed chamber of variable volume depending on relative linear displacement of the piston 14 and the cylinder 10. It should be noted commonly the cylinder 10 is generally stationary, while the piston 14 moves therein; however, this should not be considered limiting in that in other embodiments the piston 14 and piston rod 15 there attached may be generally stationary, while the cylinder 10 moves linearly Likewise, both the cylinder 10 and the piston 14 can move, while also yielding relative displacement between the cylinder 10 and the piston 14. The exemplary embodiment illustrates a single acting piston/cylinder where hydraulic fluid fills the space between the piston 14 and the end wall 12 of the cylinder 10. In another embodiment, the piston 14 and cylinder 10 may have sealed chambers on each side of the piston 14 as is well known in the art.

A measurement system 30 to measure movement of the piston 14 relative to the end wall 12 is disclosed. In one embodiment, the measurement system 30 includes an ultrasonic assembly comprising an ultrasonic transmitter 32 and two ultrasonic receivers 34 and 36 all of which are mounted stationary with respect to the end wall 12. In particular, each of the transmitter 32 and the receivers 34 and 36 are located at an end of bore or recess 42, 44 and 46, respectively. Each of the bores 42, 44 and 46 include an opening 42A, 44A, 46A, respectively, facing the piston 14 and inner walls 42B, 44B and 46B, respectively. In the embodiment of FIG. 1, the bores 42, 44 and 46 and inner walls 42B, 44B and 46B are formed in the end wall 12. The location of the transmitter 32 and the receivers 34 and 36 at the ends of the bores 42, 44 and 46, advantageously help guide or channel the ultrasonic waves from the transmitter 42 and to the receivers 44 and 46, while also providing isolation.

FIG. 1 further illustrates by way of example, a control circuit 54 that outputs an electrical signal to transmitter 32 so as to generate an ultrasonic pulse or wave that is directed to and reflects off a surface 56 facing the transmitter 32. The reflected ultrasonic pulse is received by both of the receivers 34 and 36. Each receiver 34 and 36 converts the ultrasonic pulse to an electric signal that is provided to control circuit 54 as inputs. The electric input signal from the receiver 34 is indicative of a distance X₁ between the ultrasonic transmitter 32 and the ultrasonic receiver 34. The electrical signal from receiver 36 represents the distance between the ultrasonic transmitter 32 and the receiver 36 and this is equal to X₁+X₂ where X₂ is the distance between receiver 34 and receiver 36. Since the distance X₂ between the receivers 34 and 36 is fixed, and since the time difference between the input signals of the receivers 34 and 36 can be ascertained; changes in the time difference between receipt of the input signals from the receivers 34 and 36 is indicative of acoustic characteristics of the hydraulic fluid in the cylinder 10. If, for example, the distance of the piston 14 from the end wall 12 is based on the difference in time from transmission of the ultrasonic pulse by transmitter 32 and receipt of the input signal from receiver 34, a correction signal can be ascertained by comparing the time difference between receipt of the input signals from the receivers 34 and 36 to that of a known or expected reference value. Schematically, control circuit 54 includes a timer 64 and 66 for each of the receivers 34 and 36, respectively, that is started upon receipt of an input signal from an ultrasonic pulse generator 58. A distance calculation and correction circuit 60 also receives an input signal from ultrasonic pulse generator 58 as well as inputs indicative of the elapsed time from each of timers 64 and 66. The distance calculation and correction circuit 60 ascertains a correction that is possibly needed based on the distance between the receivers 34 and 36 as ascertained based on the measured time difference by timers 64 and 66 of the ultrasonic pulse versus the actual distance between the receivers 34 and 36. The calculated correction is used to correct the ascertained distance between the end wall 12 and the piston 14, which is based on the time taken for the transmitted pulse to reach either receiver 34 and 36. It should be noted the control circuit 54 is illustrated and described functionally for purposes of understanding only. The functional components can be combined or separated as desired as well as implemented using digital and/or analog circuitry.

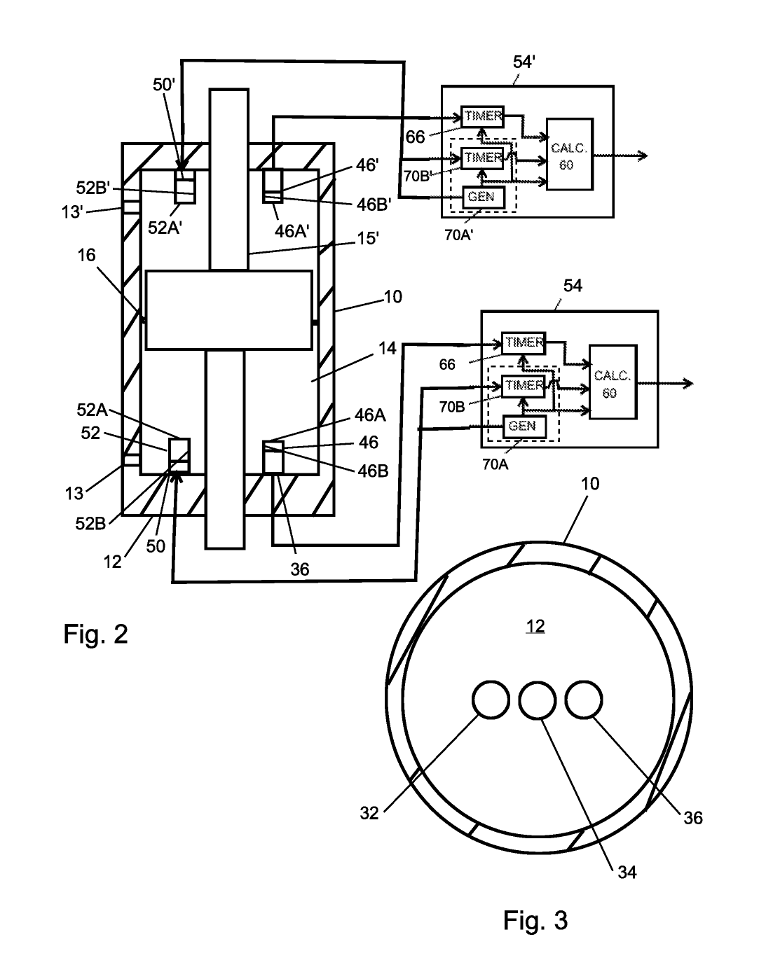

FIG. 2 illustrates possible alternative embodiments in a number of different aspects. First, the embodiment illustrates an alternative construction of an ultrasonic assembly. In particular, in this embodiment, the transmitter and one of the receivers are combined to form a single ultrasonic transducer 50. Like in the embodiment of FIG. 1, the transducer 50 is located at an end of a bore or recess 52 having an opening 52A and an inner wall 52B. In this embodiment, the bore 52 is formed in a tube 56 secured to or formed integrally with the end wall 12 from a single unitary body. Similarly, the receiver 34 is located in a tube 56 that provides the bore or recess 44, opening 44A and inner wall 44B and is secured to or formed integrally with the end wall 12 from a single unitary body. In operation, the ultrasonic transducer 50 is controlled by generator 70A to operate during a first time period as an ultrasonic transmitter to generate an ultrasonic pulse using a driven oscillating member; and then in a second time period following the first time period, the ultrasonic transducer 50 is allowed to detect the ultrasonic pulse due to the oscillating member being driven by the received ultrasonic pulse. The timer 70B measures the time difference of the oscillating member generating the ultrasonic pulse and then subsequently detecting the ultrasonic pulse. The distance calculation and correction circuit 60 receives an input signal from ultrasonic pulse generator 58 as well as inputs indicative of the elapsed time from each of timers 70A and 70B and calculates the distance of the piston 16 from the end wall 12 in a manner similar to that described above.

FIG. 2 further illustrates the use of an optional second measurement system to ascertain the position of the piston 16 in the cylinder 10. In this embodiment, the second measurement system is similar to the measurement system described above, where similar functioning components have the same reference number but are further identified with a prime (′) notation. The second measurement system in effect provides redundancy where outputs of each of the control circuits 54 and 54′ can be used separately or in combination to verify accuracy of the ascertained position of the piston 16. It should be noted the embodiments of FIGS. 1 and 2 should not be considered limiting in that in yet another embodiment, the transmitter 32, receivers 34, 36, 36′ or transducers 50, 50′ can be located in recesses or bores formed partially by tubes and partially within the end wall 12.

Although the present invention has been described with reference to preferred embodiments, workers skilled in the art will recognize that changes may be made in form and detail without departing from the spirit and scope of the invention.

What is claimed is:

1. A hydraulic apparatus comprising:
a cylinder having an end wall and an inner wall;
a piston disposed in the cylinder and movable with respect to the end wall; and
an ultrasonic assembly having components configured to operate as an ultrasonic transmitter and two ultrasonic receivers, each of the components secured in a fixed position to the end wall, wherein each of the components are disposed within a bore having an opening facing a surface of the piston and bounded by an inner wall, wherein at least each of the components configured to operate as the receivers are disposed in separate bores separated by a known distance in a direction toward the piston;
a control circuit connected to the components is configured to initiate generation of an ultrasonic wave from the component configured to operate as the ultrasonic transmitter and receive input signals from each of the components configured to operate as the ultrasonic receivers indicative of reflection of the ultrasonic wave off of the piston, wherein the control circuit is configured to provide an output signal indicative of a distance of the piston from the end wall accounting for acoustic characteristics of the hydraulic fluid as ascertained from changes in the time difference between receipt of the input signals from the components configured to operate as receivers.

2. The hydraulic apparatus of claim 1 wherein each of the ultrasonic transmitter and ultrasonic receivers components are separate devices.

3. The hydraulic apparatus of claim 1 wherein one component comprises an ultrasonic transducer.

4. The hydraulic apparatus of claim 1 wherein at least one of the components is disposed in recess in the end wall.

5. The hydraulic apparatus of claim 1 wherein at least one of components is disposed in a tube secured to the end wall.

6. The hydraulic apparatus of claim 1 and further comprising:
a second ultrasonic assembly having components configured to operate as an ultrasonic transmitter and two ultrasonic receivers, each of the components of the second ultrasonic assembly secured in a fixed position to a second end wall, wherein each of the components is disposed within a bore having an opening facing a second surface of the piston and bounded by an inner wall, wherein at least each of the components of the second ultrasonic assembly configured to operate as the receivers are disposed in separate bores separated by a second known distance in a second direction toward the piston; and
a second control circuit connected to the components of the second ultrasonic assembly and configured to initiate generation of a second ultrasonic wave from the component configured to operate as the ultrasonic transmitter and receive signals from each of the components of the second ultrasonic assembly configured to operate as the ultrasonic receivers indicative reflection of the second ultrasonic wave off of the piston, the second control circuit providing a second output signal indicative of a distance of the piston from the second end wall accounting for acoustic characteristics of the hydraulic fluid as ascertained from changes in the time difference between receipt of the input signals from the receivers of the second ultrasonic assembly
a second control circuit connected to the components of the second ultrasonic assembly is configured to initiate generation of an ultrasonic wave from the component of the second ultrasonic assembly configured to operate as the ultrasonic transmitter and receive input signals from each of the components of the second ultrasonic assembly configured to operate as the ultrasonic receivers indicative of reflection of the ultrasonic wave off of the piston, wherein the second control circuit is configured to provide an output signal indicative of a distance of the piston from a second end wall accounting for acoustic characteristics of the hydraulic fluid as ascertained from changes in the time difference between receipt of the input signals from the components of the second ultrasonic assembly configured to operate as receivers.

7. The hydraulic apparatus of claim 6 wherein the piston and cylinder are configured to operate as a double acting piston.

8. The hydraulic apparatus of claim 1 wherein the piston and cylinder are configured to operate as a double acting piston.
